(19) United States
(12) Patent Application Publication
(10) Pub. No.: US 2025/0264731 A1
(43) Pub. Date: Aug. 21, 2025

(54) ANTI-SLIP EYEGLASS ASSEMBLY

(71) Applicant: York TSAI, New Taipei City (TW)

(72) Inventor: York TSAI, New Taipei City (TW)

(21) Appl. No.: 18/895,817

(22) Filed: Sep. 25, 2024

(30) Foreign Application Priority Data
Feb. 19, 2024 (TW) 113201737

(51) Int. Cl. G02C 3/00

(52) U.S. Cl. CPC G02C 3/003; G02C 2200/20

(57) ABSTRACT

An anti-slip eyeglass assembly includes an eyeglass unit and a plurality of anti-slip units. The eyeglass unit has an eyeglass frame, a lens that is mounted to the eyeglass frame, and two temples that are respectively connected to two opposite sides of the eyeglass frame. The anti-slip units are detachably connected to the eyeglass unit, and are adapted to abut against a user's face.

### CROSS-REFERENCE TO RELATED APPLICATION

This application claims priority to Taiwanese Utility Model Patent application No. 113201737, filed on Feb. 19, 2024, the entire disclosure of which is incorporated by reference herein.

### FIELD

The disclosure relates to an eyeglass assembly, and more particularly to an anti-slip eyeglass assembly.

### BACKGROUND

As cycling activity becomes increasingly popular, more and more cyclists wear eyeglass assemblies during the cycling activity.

FIGS. 1 and 2 show an existing eyeglass assembly 9 for the cycling activity. The eyeglass assembly 9 includes an eyeglass frame 91, a lens 92, and a nose support 93. The eyeglass frame 91 has two temples 911 that are adapted to be fitted respectively over ears of a user (P). The lens 92 is mounted to the eyeglass frame 91 and defines a notch 920. The nose support 93 is mounted to the eyeglass frame 91 adjacent to the notch 920 and is adapted to abut against the user's (P) nose. When the user (P) wears the eyeglass assembly 9 during the cycling activity, because the temples 911 are respectively fitted over the ears of the user (P), and because the nose support 93 abuts against the user's (P) nose, the lens 92 is allowed to shield the eyes of the user (P) from being injured by external objects.

However, when the user (P) rides a bicycle, facial lipids and perspiration of the user (P) may reduce friction between the nose of the user (P) and the nose support 93. In addition, when the user (P) rides over a pothole or bumpy terrain, the eyeglass assembly 9 is likely to slip off the user's (P) face. Therefore, there is room for improvement of the eyeglass assembly 9.

### SUMMARY

Therefore, an object of the disclosure is to provide an anti-slip eyeglass assembly that can alleviate at least one of the drawbacks of the prior art.

According to the disclosure, the anti-slip eyeglass assembly includes an eyeglass unit and a plurality of anti-slip units.

The eyeglass unit has an eyeglass frame, a lens that is mounted to the eyeglass frame, and two temples that are respectively connected to two opposite sides of the eyeglass frame.

The anti-slip units are detachably connected to the eyeglass unit, and are adapted to abut against a user's face.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view illustrating an existing eyeglass assembly.

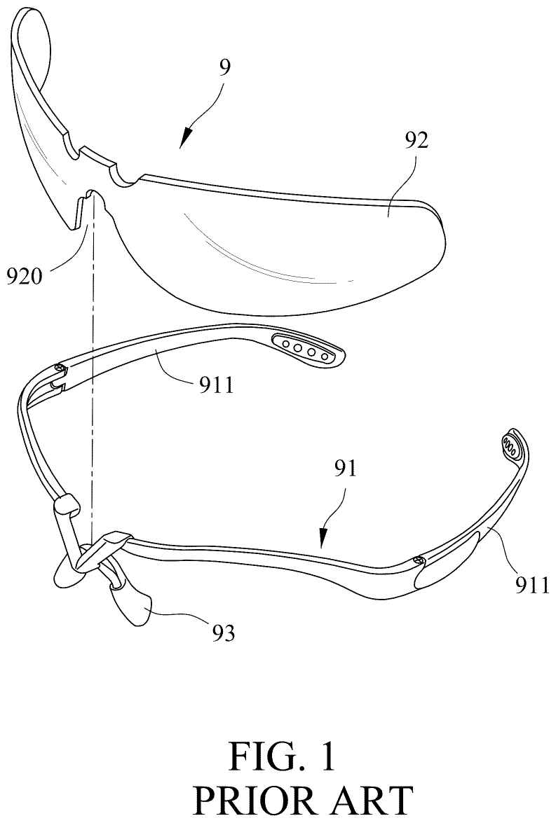

FIG. 2 is a schematic view illustrating the existing eyeglass assembly worn by a user.

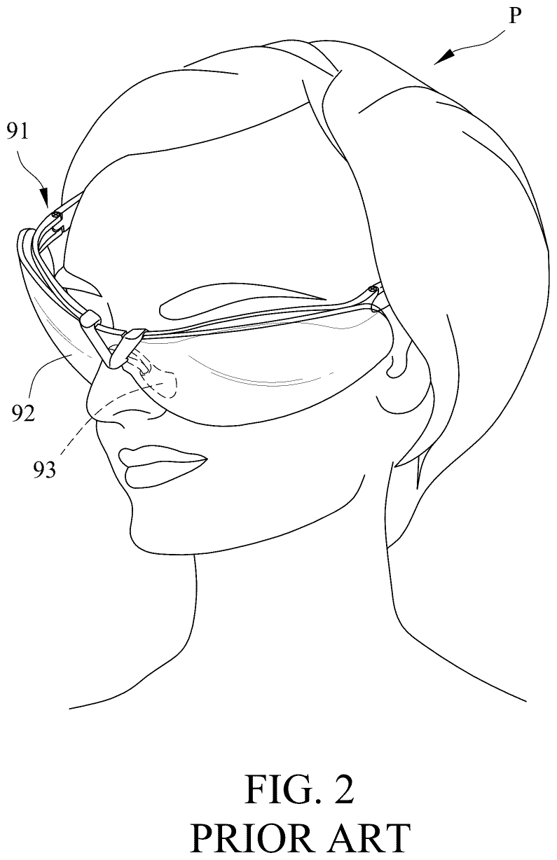

FIG. 3 is a front view illustrating an anti-slip eyeglass assembly according to a first embodiment of the disclosure.

FIG. 4 is a rear view of the first embodiment illustrating an eyeglass unit and two anti-slip units of the anti-slip eyeglass assembly.

FIG. 5 is a fragmentary schematic view of the first embodiment illustrating one of two connecting portions of the eyeglass unit.

FIGS. 6 and 7 are perspective views of the first embodiment illustrating a positioning member of one of the anti-slip units.

FIG. 8 is a fragmentary perspective view illustrating an anti-slip eyeglass assembly according to a second embodiment of the disclosure.

FIG. 9 is a fragmentary perspective view illustrating an anti-slip eyeglass assembly according to a third embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

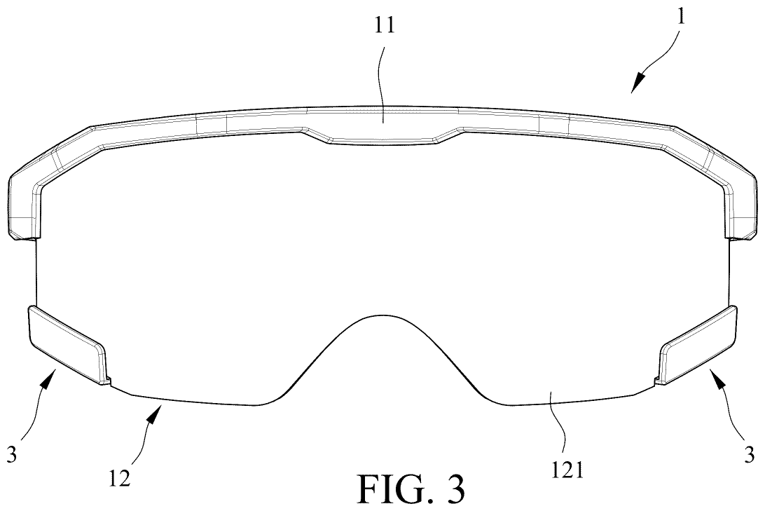

FIGS. 3 to 5 illustrate an anti-slip eyeglass assembly according to a first embodiment of the disclosure. The anti-slip eyeglass assembly of the disclosure includes an eyeglass unit 1 and two anti-slip units 3 that are detachably connected to the eyeglass unit 1. In this embodiment, the anti-slip eyeglass assembly is adapted to be worn by a user so as to shield the eyes of the user from sunlight and winds.

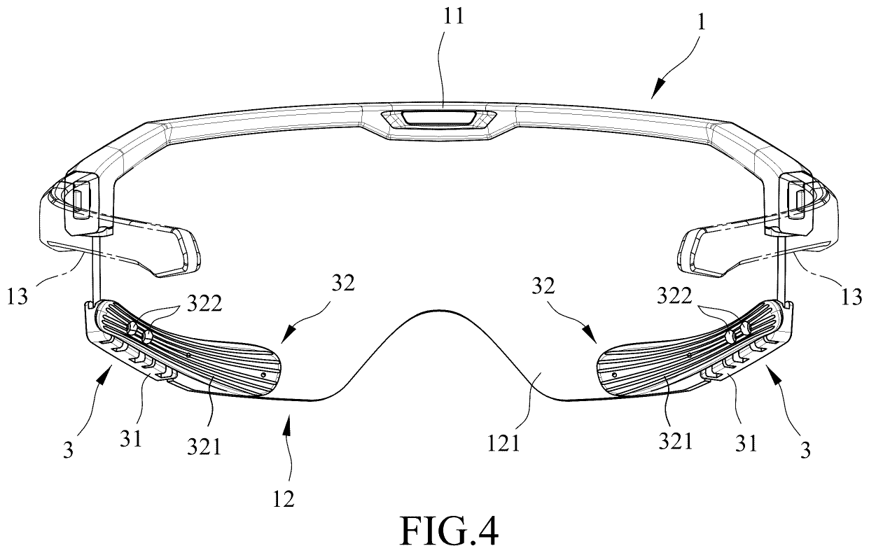

The eyeglass unit 1 has an eyeglass frame 11, a lens 12 that is mounted to the eyeglass frame 11, and two temples 13 that are respectively connected to two opposite sides of the eyeglass frame 11. As shown in FIG. 4, in this embodiment, the temples 13 are respectively and pivotally connected to two opposite sides of the eyeglass frame 11. As a result, when one of the eyeglass frame 11 and the temples 13 is broken, the eyeglass frame 11 and the temples 13 are individually replaceable.

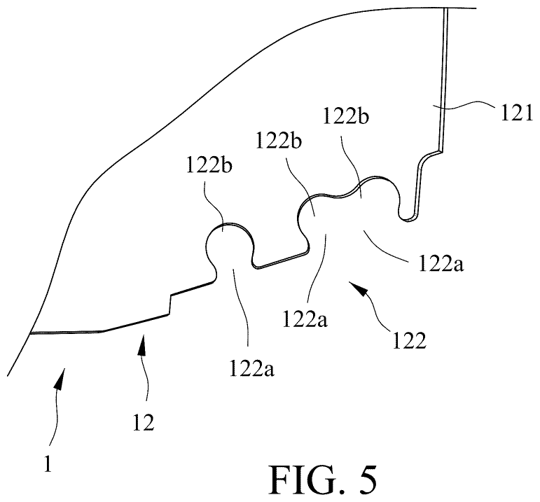

The lens 12 has a curved lens body 121 that is adapted to go around the user's face. The curved lens body 121 has two connecting portions 122 (only one is shown in FIG. 5) that are disposed on a bottom end of the curved lens body 121 and that are spaced apart from each other. The connecting portions 122 of the curved lens body 121 are respectively connected to the anti-slip units 3 (details of the anti-slip units 3 will be described hereinafter). Each of the connecting portions 122 has three positioning recesses 122b. One of the positioning recesses 122b is spaced apart from the other two of the positioning recesses 122b. Each of the positioning recesses 122b has a recess opening 122a that is open at a bottom edge of the curved lens body 121. As long as the connecting portions 122 of the curved lens body 121 and the anti-slip units 3 are fixedly connected, each of the positioning recesses 122b of each of the connecting portions 122 is not limited in shape.

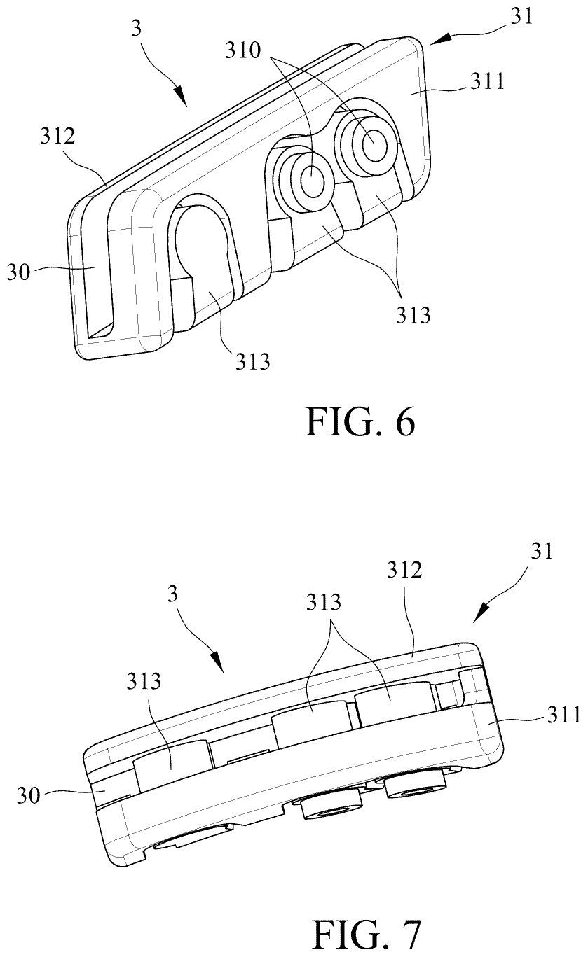

Referring to FIGS. 6 and 7 in combination with FIGS. 3 to 5, the anti-slip units 3 are detachably connected to the lens 12 of the eyeglass unit 1 and not in contact with the eyeglass frame 11. Each of the anti-slip units 3 includes a positioning member 31 and an anti-slip member 32 that is connected to the positioning member 31 and that is adapted to abut against the user's face. As shown in FIGS. 6 and 7, the positioning member 31 of each of the anti-slip units 3 has a first positioning plate 311, a second positioning plate 312, and three positioning rods 313. The first positioning plate 311 is adapted to be disposed between an inner side of the curved lens body 121 and the user's face. The second positioning plate 312 is spaced apart from the first positioning plate 311, is disposed on an outer side of the curved lens body 121, and cooperates with the first positioning plate 311 to define an insertion space 30 into which a respective one of the connecting portions 122 of said lens 12 is inserted. The positioning rods 313 extend transversely through the insertion space 30, and are respectively engaged with the positioning recesses 122b of the respective one of the connecting portions 122 of the lens 12. A width of each of the positioning rods 313 is not smaller than a width of the recess opening 122a of the respective one of the positioning recesses 122b. In this embodiment, for each of the anti-slip units 3, the positioning member 31 has a plurality of positioning holes 310. Each of the positioning rods 313 is designed to conform in shape to the respective one of the positioning recesses 122b such that each of the positioning rod 313 is fixedly engaged with the respective one of the positioning recesses 122b.

As shown FIG. 4, the anti-slip member 32 of each of the anti-slip units 3 has a plurality of anti-slip strips 321 and a plurality of joining holes 322. The anti-slip strips 321 are spaced apart from each other, extend in a same direction, and are adapted to abut against the user's face. The joining holes 322 are respectively aligned with the positioning holes 310, such that each of the positioning holes 310 and a respective aligned one of the joining holes 322 are adapted to be engaged with a screw. For each of the anti-slip units 3, when screws extend through and are engaged with the positioning holes 310 and the joining holes 322, the anti-slip member 32 is fixed to the positioning member 31. In this embodiment, each of the screws is a countersunk flat screw (not shown) so that the screws are unlikely to protrude outwardly from the anti-slip member 32 and to be in frictional contact with the user's face. As a result, comfort of wearing the anti-slip eyeglass assembly may be ensured.

Specifically, in order for the anti-slip member 32 of each of the anti-slip units 3 to conform to a contour of the user's face when the anti-slip eyeglasses assembly is worn, the anti-slip member 32 of each of the anti-slip units 3 is curved in design, so that the anti-slip member 32 of each of the anti-slip units 3 stably abuts against cheekbones of the user. By virtue of abutments of the anti-slip members 32 of the anti-slip units 3 and the cheekbones of the user, an overall weight of the anti-slip eyeglass assembly may be supported, and a satisfactory anti-slip effect may be achieved.

In this embodiment, when the user wears the anti-slip eyeglass assembly, the temples 13 are fitted respectively over ears of the user, so the curved lens body 121 is situated forwardly of the eyes of the user. For example, when the user wears the anti-slip eyeglass assembly and rides a bicycle, because the positioning members 31 of the anti-slip units 3 are respectively and fixedly engaged with the connecting portions 122 that are disposed on the bottom end of the curved lens body 121 and that are spaced apart from each other in a left-right direction, weights of the eyeglass frame 11 and the lens 12 are evenly supported by the anti-slip units 3 from the bottom end of the curved lens body 121. As a result, when the user wearing the anti-slip eyeglass assembly rides the bicycle over bumpy terrain, shaking of the anti-slip eyeglass assembly may be evenly distributed to the user's face. In comparison with nose supports of an existing eyeglass assembly in which only a relatively small area abuts against the user's face, the overall weight of the anti-slip eyeglass assembly of the disclosure and the shaking of the anti-slip eyeglass assembly of the disclosure may be evenly distributed to the user's face. Because a weight per unit area of the anti-slip eyeglass assembly in contact with the user's face is relatively small, static friction between the anti-slip eyeglass assembly and the user's face is likely to prevent slipping of the anti-slip eyeglass assembly, thereby achieving an anti-slip effect which prevents the anti-slip eyeglass assembly from slipping off the user face.

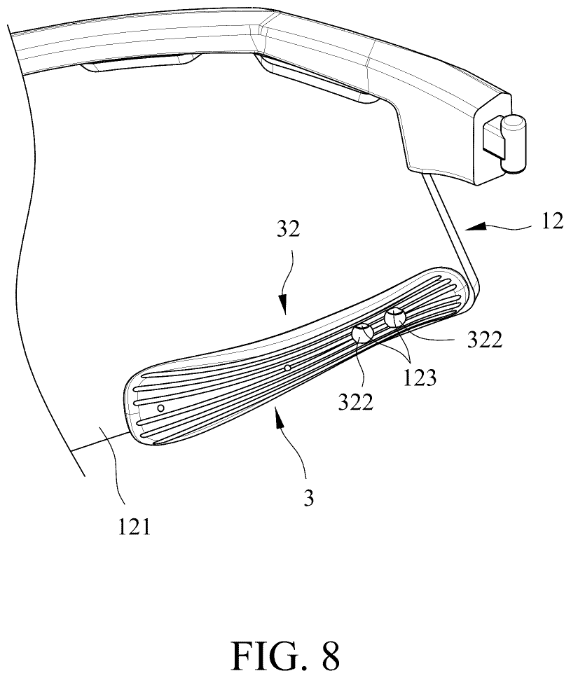

FIG. 8 illustrates an anti-slip eyeglass assembly according to a second embodiment of the disclosure, which has a structure generally similar to that of the first embodiment. However, the connecting portions 122 of the lens 12 and the positioning members 31 of the anti-slip units 3 are omitted. In this embodiment, the curved lens body 121 is formed with four fastening holes 123. Two of the fastening holes 123 are disposed on and extend through a side of the curved lens body 121, and are adapted to be engaged with two screws that secure one of the anti-slip units 3 on the curved lens body 121. Another two of the fastening holes 123 are disposed on and extend through an opposite side of the curved lens body 121, and are adapted to be engaged with two screws that secure another one of the anti-slip units 3 on the curved lens body 121. As shown in FIG. 8, the anti-slip unit 3 is secured to the curved lens body 121 by the screws extending into and engaged with the joining holes 322 of the anti-slip member 32 and the fastening holes 123 of the curved lens body 121.

In the second embodiment, by virtue of the fastening holes 123 of the curved lens body 121 in cooperation with the joining holes 322 of the anti-slip members 32 of the anti-slip units 3, the anti-slip members 32 of the anti-slip units 3 may be conveniently detached from the curved lens body 121 by removing the screws from the fastening holes 123 of the curved lens body 121 and the joining holes 322 of the anti-slip members 32 of the anti-slip units 3 for cleaning or maintaining the anti-slip eyeglass assembly of the disclosure.

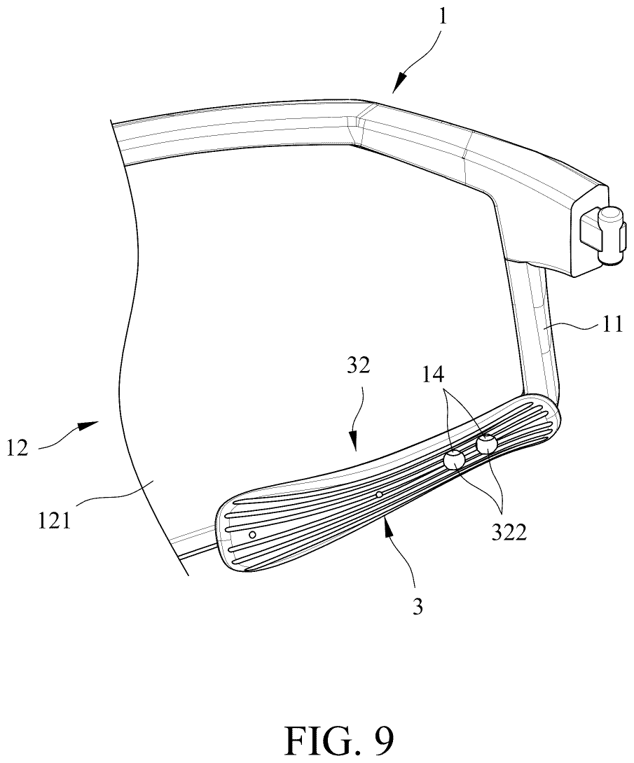

FIG. 9 illustrates an anti-slip eyeglass assembly according to a third embodiment of the disclosure. In this embodiment, the connecting portions 122 of the lens 12 and the positioning member 31 of the anti-slip units 3 are omitted. In addition, the anti-slip units 3 are directly and detachably connected to the eyeglass frame 11 of the eyeglass unit 1, and the eyeglass unit 1 further has four fixing holes 14 that extend through the eyeglass frame 11. Two of the fixing holes 14 are disposed on a side of the curved lens body 121, and are adapted to be engaged with two screws that secure one of the anti-slip units 3 on the eyeglass frame 11. Another two of the fixing holes 14 are disposed on an opposite side of the curved lens body 121, and are adapted to be engaged with two screws that secure another one of the anti-slip units 3 to the eyeglass frame 11. As shown in FIG. 9, the anti-slip unit 3 is secured to the curved lens body 121 by the screws extending into and engaged with the joining holes 322 of the anti-slip member 32 and the fixing holes 14. In the third embodiment, because the fixing holes 14 extend through the eyeglass frame 11, and because the eyeglass frame 11 is stronger in structure than the curved lens body 121, when the anti-slip members 32 of the anti-slip units 3 are secured to the eyeglass frame 11 by the screws, connection strengths of the anti-slip units 3 to the eyeglass frame 11 are enhanced. In addition, the anti-slip members 32 of the anti-slip units 3 may be rapidly detached from the eyeglass frame 11 by removing the screws from the fixing holes 14 and the joining holes 322 for cleaning or maintaining the anti-slip eyeglass assembly of the disclosure.

In summary, when the anti-slip eyeglass assembly of the disclosure is worn by the user, in comparison with the nose supports of the existing eyeglass assembly abutting against the user's nose, because the anti-slip members 32 of the anti-slip units 3 abut against the user's face, areas of the anti-slip eyeglass assembly of the disclosure in contact with the user's face are increased, and the overall weight of the anti-slip eyeglass assembly of the disclosure may be uniformly distributed to the user's face. By virtue of the anti-slip members 32 of the anti-slip units 3 abutting against the user's face, the anti-slip eyeglass assembly of the disclosure may effectively be prevented from slipping off the user's face.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An anti-slip eyeglass assembly comprising:
an eyeglass unit having
an eyeglass frame,
a lens that is mounted to said eyeglass frame, and
two temples that are respectively connected to two opposite sides of said eyeglass frame; and
a plurality of anti-slip units detachably connected to said eyeglass unit, and adapted to abut against a user's face.

2. The anti-slip eyeglass assembly as claimed in claim 1, wherein said anti-slip units are detachably connected to said lens of said eyeglass unit and not in contact with said eyeglass frame.

3. The anti-slip eyeglass assembly as claimed in claim 2, wherein:
a quantity of said anti-slip units is two;
said lens has a curved lens body that is adapted to go around the user's face and that is formed with four fastening holes;
two of said fastening holes are disposed on and extend through a side of said curved lens body, and are adapted to be engaged with two screws that secure one of said anti-slip units on said curved lens body; and
another two of said fastening holes are disposed on and extend through an opposite side of said curved lens body, and are adapted to be engaged with two screws that secure another one of said anti-slip units on said curved lens body.

4. The anti-slip eyeglass assembly as claimed in claim 2, wherein:
a quantity of said anti-slip units is two;
said lens has a curved lens body that is adapted to go around the user's face, and that has two connecting portions disposed on a bottom end of said curved lens body and spaced apart from each other, each of said connecting portions has at least one positioning recess; and
each of said anti-slip units includes
a positioning member that defines an insertion space into which a respective one of said connecting portions of said lens is inserted, and that has at least one positioning stud extending transversely through said insertion space, and
an anti-slip member that is connected to said positioning member and that is adapted to abut against the user's face.

5. The anti-slip eyeglass assembly as claimed in claim 4, wherein:
said at least one positioning recess of each of said connecting portions of said lens includes a plurality of positioning recesses; and
said at least one positioning stud of said positioning member of each of said anti-slip units includes a plurality of positioning rods that are respectively engaged with said positioning recesses of the respective one of said connecting portions of said lens.

6. The anti-slip eyeglass assembly as claimed in claim 4, wherein said positioning member of each of said anti-slip units has
a first positioning plate that is adapted to be disposed between an inner side of said curved lens body and the user's face, and
a second positioning plate that is spaced apart from said first positioning plate, that is disposed on an outer side of said curved lens body, and that cooperates with said first positioning plate to define said insertion space.

7. The anti-slip eyeglass assembly as claimed in claim 4, wherein, for each of said anti-slip units, said positioning member has a plurality of positioning holes, and said anti-slip member has a plurality of joining holes that are respectively aligned with said positioning holes, such that each of said positioning holes and a respective aligned one of said joining holes are adapted to be engaged with a screw.

8. The anti-slip eyeglass assembly as claimed in claim 1, wherein said anti-slip units are directly and detachably connected to said eyeglass frame of said eyeglass unit.

9. The anti-slip eyeglass assembly as claimed in claim 8, wherein:
a quantity of said anti-slip units is two;
said lens has a curved lens body that is adapted to go around the user's surface;
said eyeglass unit further has four fixing holes that extend through said eyeglass frame;
two of said fixing holes are disposed on a side of said curved lens body, and are adapted to be engaged with two screws that secure one of said anti-slip units on said eyeglass frame; and
another two of said fixing holes are disposed on an opposite side of said curved lens body, and are adapted to be engaged with two screws that secure another one of said anti-slip units to said eyeglass frame.
